(19) United States
(12) Patent Application Publication
(10) Pub. No.: US 2025/0114696 A1
(43) Pub. Date: Apr. 10, 2025

(54) ENCODING/TRANSMITTING ONLY Y-CHANNEL DATA IN COMPUTER GAME VIDEO

(71) Applicant: Sony Interactive Entertainment Inc., Tokyo (JP)

(72) Inventors: Manoj Srivistava, San Mateo, CA (US); Eric Hsuming Chen, San Mateo, CA (US); Mario Sarria, San Mateo, CA (US); Hideyuki Mizusawa, San Mateo, CA (US)

(21) Appl. No.: 18/481,905

(22) Filed: Oct. 5, 2023

(51) Int. Cl. A63F 13/355

(52) U.S. Cl. CPC A63F 13/355; A63F 2300/534

(57) ABSTRACT

Techniques are described for delivering video such as computer game video over a network with minimal latency by converting the video to Y-U-V video and then sending only the luminance data (Y-channel) to end users. Color can be reconstructed on the receiver end using color tables and/or machine learning.

### FIELD

The present application relates to technically inventive, non-routine solutions that are necessarily rooted in computer technology and that produce concrete technical improvements, and more specifically to encoding/transmitting only Y-channel data in computer game video.

### BACKGROUND

Video such as computer simulation video such as computer game video may be streamed to end user terminals over a network.

### SUMMARY

As understood herein, network conditions and/or regulatory-imposed network regulations regarding bandwidth limitations for energy saving may limit the network channel available to send a video such as a computer game video. As further understood herein, particularly in the case of computer gamers, latency is a principal concern under such conditions, because gamers prefer near-instantaneous reaction to their inputs, for example when shooting game weapons. Video quality may thus be less of a concern than delivering video with little to no latency.

Accordingly, an apparatus includes at least one processor assembly configured to encode at least one video in YUV format, and send, to at least one receiver, only Y-channel information from the UV format over at least one computer network to minimize latency.

The video may be, e.g., computer game video.

In some examples, the processor assembly may be configured to send, along with the Y-channel information, at least one hint indicating color. The hint may be, e.g., one or more of at least one RGB frame, an indication of shadow in the video, an indication of depth in the video, an indication of reflections in the video, an indication of object surface type in the video, an indication of object height in the video, an indication of scene type in the video.

If desired, the processor assembly may be configured to send the hint responsive to a scene change in the video.

In another aspect, an apparatus includes at least one computer medium that is not a transitory signal and that in turn includes instructions executable by at least one processor assembly to receive, from at least one transmitter, a Y-channel of data of at least one video but not a U-channel or V-channel of data of the video. The instructions are executable to reconstruct color of the video, and present on at least one display the video in color.

In another aspect, a method includes transmitting Y-channel data of a video encoded in YUV format to at least one receiver but not transmitting U-channel or V-channel data of the video to the receiver. The method also includes, at the receiver, colorizing the Y-channel data and presenting the video in color.

The details of the present disclosure, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system including an example in consistent with present principles;

FIG. 2 illustrates an example encoder-decoder system;

FIG. 3 illustrates example transmitter logic in example flow chart format;

FIG. 4 illustrates example receiver logic in example flow chart format;

FIG. 5 illustrates further example transmitter logic in example flow chart format;

FIG. 6 illustrates still further example transmitter logic in example flow chart format;

FIG. 7 illustrates further example receiver logic in example flow chart format;

FIG. 8 illustrates still further example receiver logic in example flow chart format; and

FIG. 9 illustrates example machine learning (ML) model training logic in example flow chart format.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry. A processor assembly may include one or more processors.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

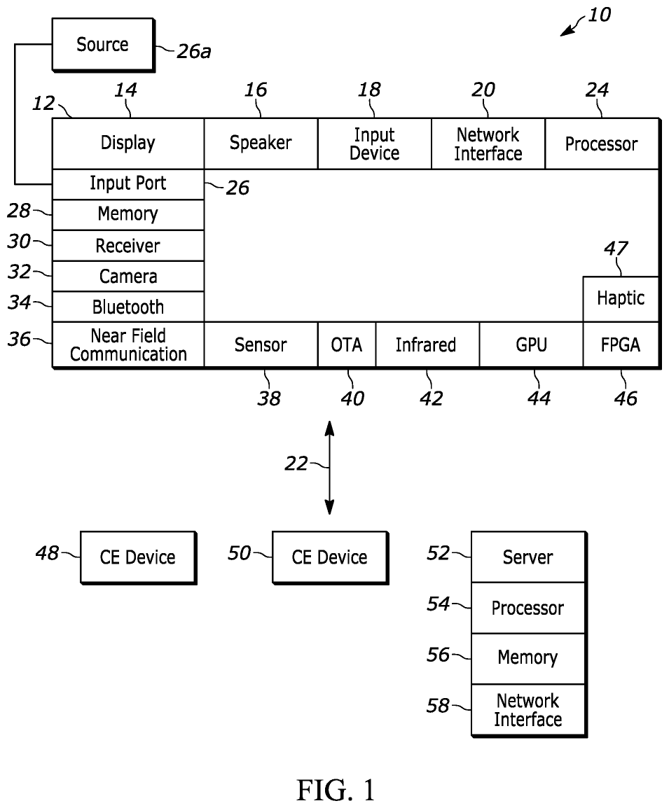

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that that are configured and weighted to make inferences about an appropriate output.

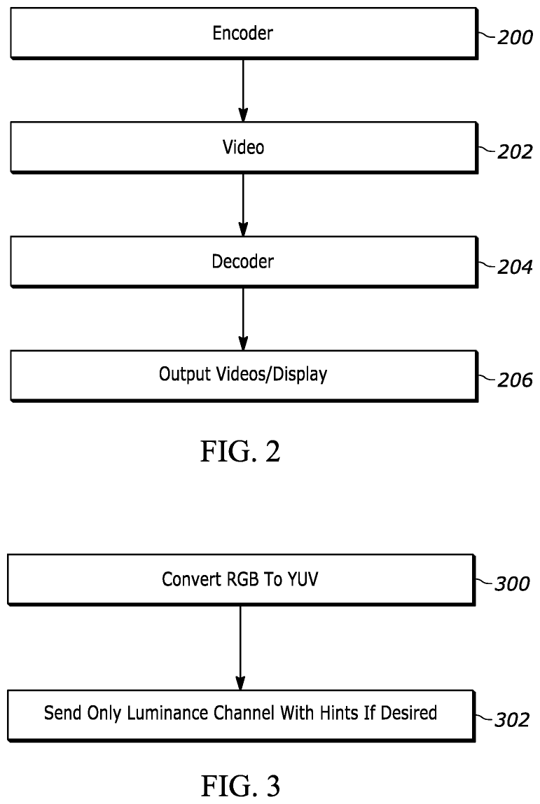

FIG. 2 illustrates a system that includes a video encoder 200 for encoding/compressing videos 202. A video decoder 204 can receive the encoded videos via a wired or wireless communication path and decode/decompress them into output videos 206.

FIG. 3 illustrates example general logic of a transmitter of video such as computer simulation video such as computer game video, it being understood that present principles may apply to movie video and TV video as well. Commencing at state 300, if the video is not already in YUV format and instead is in RGB format, it is converted to YUV format. Then, at block 302 only pixel luminance data, i.e., only the Y-channel data in the YUV format, is transmitted to a receiver, for instance over a computer network. Pixel color data, including the U-channel and V-channel data, is not transmitted; however, a small amount of “hint” data also may be sent with the Y-channel luminance data to help the receiver recover color before rendering the video.

For example, the hint data may include one or more of shadow data for the image, depth data for the image, reflections data for the image, object surface type data for the image, and object height data for the image. The hint data may include a partial or full RGB frame from the original video sent periodically to refresh the receiver. Yet again, the hint data may include a scene type, e.g., high motion scene, low motion scene (generally, amount of motion in the scene), ocean scene, forest scene, sky scene, space scene (generally, scene environment), shooting scene, driving scene (generally, type of action in the scene). Thus, the hint data may be less than a full chroma map.

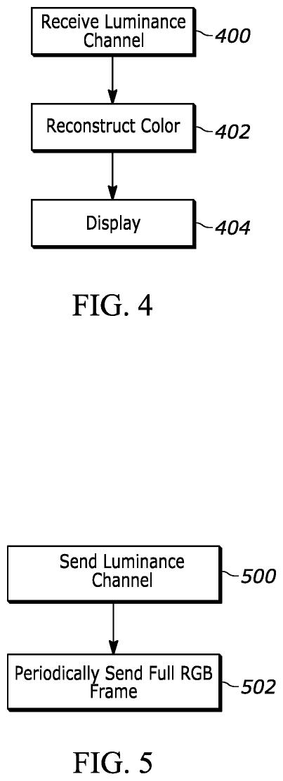

Receiver side logic is illustrated in FIG. 4. Commencing at state 400, the luminance channel data is received. Color may be reconstructed for the video at block 402 consistent with disclosure herein, the colorized video presented on a video display at block 404.

FIG. 5 illustrates further details of an example embodiment. The transmitter sends only the Y-channel data at block 500. Then, at block 502, periodically the transmitter may send a partial or full RGB frame from the video to the receiver to refresh the receiver by providing the receiver with per-pixel color data directly, from which the receiver can deduce color for subsequent frames by using the same color for similar objects that may be recognized frame to frame.

Note that in the case of movies, offline analysis of the color of the movies may be used and provided as hint data to help the receiver reconstruct color.

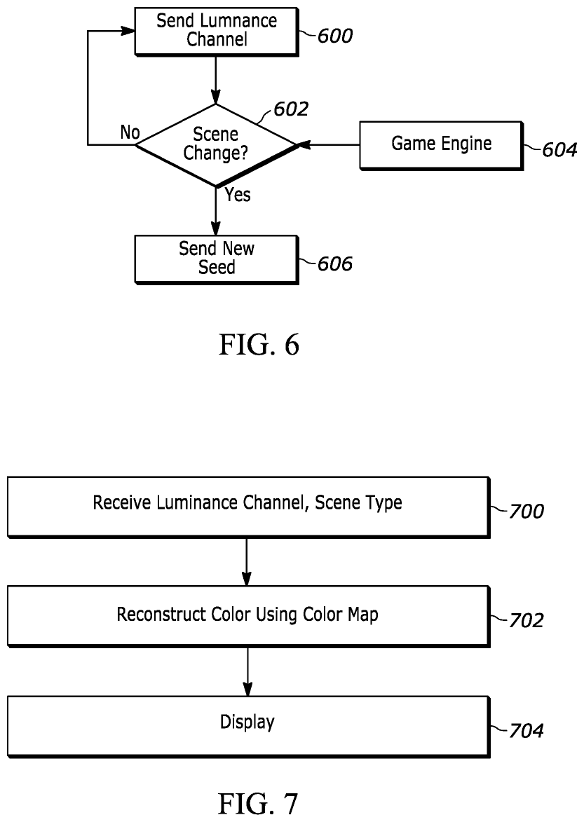

FIG. 6 illustrates that in the case of computer game video, Y-channel data is transmitted at block 600 but not U-channel or V-channel, and when a scene change in the video is identified at state 602 as may be signaled by a computer game engine 604, a new color “seed” such as any of the hints described herein may be transmitted at state 606 to the receiver to refresh the colorization circuitry of the receiver. The game engine can cast the seed early, i.e., a short time period prior to the scene change, knowing it's needed on the receiver to get ready.

FIG. 7 illustrates a technique in which a color map is used with or without machine learning (ML) to reconstruct color at the receiver from the Y-channel luminance data. Commencing at state 700, the luminance data is received along with a hint, in the example shown, a type of scene as discussed previously. Moving to state 702, color of the video is reconstructed using a color map which maps luminance data to a colorized version of the video, and at block 704 the colorized version of the video is presented on a video display.

The technique of FIG. 7 may further leverage scene type information in implementing the colorization using the color map. For example, for a scene type of “sky”, a color map of primarily a blue palette may be used, whereas for a scene type of “forest”, a color map of primarily a green palette may be used. Scene types thus may be correlated to respective color maps.

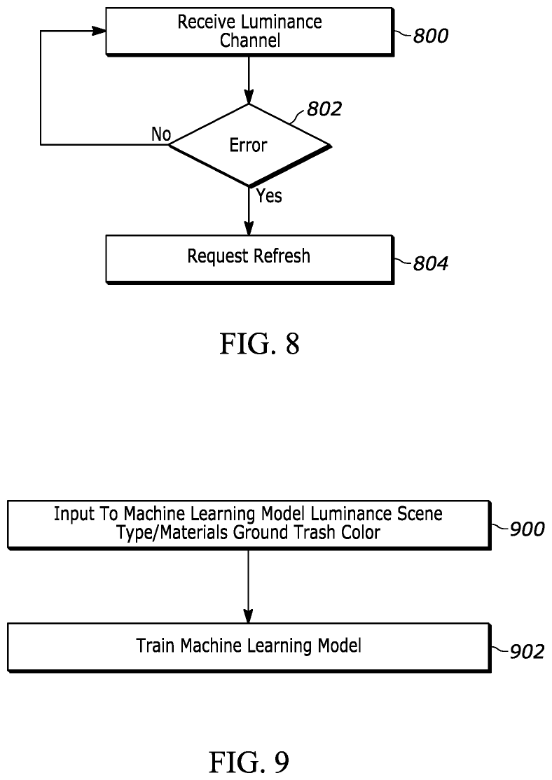

FIG. 8 illustrates receiver side logic for requesting a color hint from the transmitter when video errors accumulate to meet a threshold. The luminance-only data is received at state 800, and if it is determined at state 802, a request is sent to the transmitter at state 804 for refresh information related to color.

Thus for example, a previous hint may have been provided by the game engine that a particular object such as an alley should be visible in the current scene, and if image recognition techniques employed by the receiver indicate that no such object is clearly visible in the video being presented, a request may be made for a new color hint. Such errors may occur when, for example, an object is miscolored to blend in with another object. Other error parameters that may be used consistent with FIG. 8 include forward error correction (FEC), checksums, and picture order count (POC). A scene shadow for example could act as checksum, i.e., if a shadow is present in the displayed video but no shadow is signaled from the transmitter, a checksum error can be returned to request a color refresh.

FIG. 9 illustrates ML model training techniques. Commencing at state 900, a training set of data is input to a ML model to train the model at state 902 for use as appropriate in techniques described herein. The training set may include ground truth Y-channel data, scene type, and/or materials of objects in the scene, and/or other hints for recovering color as described herein, along with ground truth pixel by pixel color information.

While particular techniques are herein shown and described in detail, it is to be understood that the subject matter which is encompassed by the present application is limited only by the claims.

What is claimed is:

1. An apparatus comprising:
at least one processor assembly configured to:
encode at least one video in YUV format;
send, to at least one receiver, only Y-channel information from the YUV format over at least one computer network to minimize latency.

2. The apparatus of claim 1, wherein the video comprises computer game video.

3. The apparatus of claim 1, wherein the processor assembly is configured to send, along with the Y-channel information, at least one hint for color reconstruction.

4. The apparatus of claim 3, wherein the hint comprises at least one RGB frame.

5. The apparatus of claim 3, wherein the hint comprises at least one indication of shadow in the video.

6. The apparatus of claim 3, wherein the hint comprises at least one indication of depth in the video.

7. The apparatus of claim 3, wherein the hint comprises at least one indication of reflections in the video.

8. The apparatus of claim 3, wherein the hint comprises at least one indication of object surface type in the video.

9. The apparatus of claim 3, wherein the hint comprises at least one indication of object height in the video.

10. The apparatus of claim 3, wherein the hint comprises at least one indication of scene type in the video.

11. The apparatus of claim 3, wherein the processor assembly is configured to send the hint responsive to a scene change in the video.

12. An apparatus comprising:
at least one computer medium that is not a transitory signal and that comprises instructions executable by at least one processor assembly to:
receive, from at least one transmitter, a Y-channel of data of at least one video but not a U-channel or V-channel of data of the video;
reconstruct color of the video; and
present on at least one display the video in color.

13. The apparatus of claim 12, wherein the video comprises at least one computer game video.

14. The apparatus of claim 12, wherein the instructions are executable to:
reconstruct the color of the video based at least in part on at least one hint received with the video.

15. The apparatus of claim 14, wherein the hint comprises at least one RGB frame.

16. The apparatus of claim 14, wherein the hint comprises at least one of:
an indication of shadow in the video;
an indication of depth in the video;
an indication of reflections in the video;
an indication of object surface type in the video;
an indication of object height in the video.

17. The apparatus of claim 14, wherein the hint comprises at least one indication of scene type in the video.

18. The apparatus of claim 12, wherein the instructions are executable to:
input the Y-channel data to at least one machine learning (ML) model; and
reconstruct the color of the video based at least in part on an output from the ML model.

19. A method, comprising:
transmitting Y-channel data of a video encoded in YUV format to at least one receiver but not transmitting U-channel or V-channel data of the video to the receiver;
at the receiver, colorizing the Y-channel data; and
presenting the video in color.

20. The method of claim 19, wherein the video comprises computer game video.
